(19) United States
(12) Patent Application Publication
(10) Pub. No.: US 2003/0053889 A1
(43) Pub. Date: Mar. 20, 2003

(54) Method and device for the production of security elements for electronic article surveillance and corresponding security element

(76) Inventors: Detlef Duschek, Sensbachtal (DE); Gordon Klassen, Duarte, CA (US)

Correspondence Address: Felix J. D'Ambrosio, Jones, tullar & Cooper, P.C., P.O. Box 2266 Eads Station, Arlington, VA, 22202, US

(21) Appl. No.: 10/194,286

(22) Filed: Jul. 15, 2002

Related U.S. Application Data
(62) Division of application No. 09/423,871, filed on Nov. 15, 1999, now Pat. No. 6,494,660.

(30) Foreign Application Priority Data
May 15, 1997 (DE) 197 20 319.1

(51) Int. Cl. B42C 1/00; B42B 2/00

(52) U.S. Cl. 412/1

(57) ABSTRACT

The invention is directed to a method and a device for the production of security elements for electronic article surveillance, said security elements being comprised of at least two layers, as well as to a web material manufactured by means of said method.

The object of the invention is to propose a simple, economical method, a corresponding device for the production of web material, as well as a web material manufactured by said method for the purposes of electronic article surveillance.

The object of the invention with regard to the method is accomplished in that sections (6) of a predetermined length cut from a second material web (2) are conveyed in a direction transverse to the running direction (x) of a first continuous material web (1) and are applied to said first material web (1).

This invention relates to a method and a device for the production of security elements for electronic article surveillance as well as to a corresponding security element, one security element being comprised of at least two layers.

The goods in department stores and warehouses are being protected from theft increasingly by electronic devices. One way to guard against theft by electronic surveillance is to attach strip elements, meaning clongate soft magnetic pieces of metal (e.g., VITROVAC from the Vacuumschmelze company), to the goods. These strip elements trigger an alarm when present in corresponding monitoring systems, which are usually positioned in the exit area of the facility to be protected.

Electronic article surveillance can be described roughly as follows: A monitoring system has a transmit device and a receive device. The transmit device transmits an interrogating signal into a monitoring zone. This interrogating signal excites the strip element into transmitting a reply signal which is detected and identified by the receive device. The occurrence of a reply signal is equated with the unauthorized passing of an electronically protected article through the interrogation zone, and the alarm is triggered. An example of such a monitoring system is described in EP 0 123 586 A1.

Resonant security elements are used in addition to the strip-shaped security elements for electromagnetic article surveillance. These resonant security elements are comprised of a resonant circuit having capacitive and inductive elements. As soon as such a resonant circuit is exposed to a corresponding electromagnetic field inside an interrogation zone it transmits a reply signal with its resonant frequency.

It is an object of the present invention to propose a simple economical method, a corresponding device and a web material manufactured by said method for the purposes of electronic article surveillance.

The object of the invention with regard to the method is accomplished in that sections of a second web material cut to a predetermined length are conveyed in a direction transverse to the running direction of a first continuous material web and are applied to said first material web An application example of web materials produced in this manner follows below.

The previously mentioned strip elements for electronic article surveillance come in a length of several centimeters (e.g., 3 cm). Labels, each containing one strip element, are conventionally provided in the form of a roll of labels and dispensed by means of suitable dispensing devices. If—as is usual—the strip elements measuring several centimeters in length are wound up in longitudinal direction to a roll of labels, one roll of labels will contain relatively few labels. The picture is quite different, however, if the strip elements are wound up in transverse direction to the dispensing direction. It is then possible to materially increase the number of strip elements per roll of labels.

The transverse arrangement of the strip elements affords particular advantages when it is considered how these strip elements are normally produced: A relatively wide soft magnetic endless strip is produced; this endless strip is subsequently split into several soft magnetic endless strips lying in side-by-side arrangement. A label applied from the side to the first material web thus contains several parallel strip elements. This way it is possible to achieve a further notable reduction in elements.

According to a further application example, sections cut from a thin-film material are applied to an endless strip made of thin-film material (materials of this type are described in detail in EP 0 295 028). For production-related reasons, thin-film materials display a preferential direction, i.e., the reply signal is at its maximum level when the interrogation field is oriented parallel to this preferential direction but is at zero level when the angle of incidence is perpendicular to the preferential direction. If two layers of thin-film materials are arranged perpendicular to each other, the security element in question will always be excited into transmitting a reply signal regardless of its orientation in the interrogation zone.

The method of the present invention is characterized in that according to an advantageous further aspect the sections of predetermined length cut from the second material web can be applied to the first material web in steps or continuously. The advantage of the continuous method is, of course, the higher production rate.

The object of the present invention with regard to the device is accomplished in that a guide device is provided for a first material web, at least one dispensing device for feeding the sections of a predetermined length cut from a second material web is provided at right angles to the guide device, and a conveying device is provided to take successively from the dispensing device those sections of predetermined length cut from the second material web and affix them to the first material web either directly side by side or with a gap in between.

While in use of just a single dispensing device the sections are applied to the first material web insteps, with two or more dispensing devices it is possible for the device of the invention to work continuously. All that is necessary in this case is for there to be a certain distance between each of then dispensing devices and for the sections to be fed at a rate coordinated with the running speed of the first material web. The rate at which the sections are fed has to be set at least high enough for a section to be in the correct “ready” position as soon as that area of the first material web is reached where the section is to be applied.

According to an advantageous further aspect of the device of the present invention, provision is made for the dispensing device to be a conveyor belt, for at least one electromagnet to be positioned in the inner space formed by the revolving conveyor belt, for at least one further electromagnet to be provided in the area underneath the first material web where the sections of the second material web are to be applied to the first material web, and for a control/regulating unit to be provided to switch the electromagnets on and off so that the sections of the second material web are applied to the first material web.

Furthermore, in accordance with a favorable embodiment of the device of the present invention the following is proposed: A stop or a sensor for detecting the correct position of the section of the second material web relative to the first material web is arranged in the end zone of the conveying device; the control/regulating unit switches the first electromagnet off and the second electromagnet on as soon as the stop or the sensor signals that the section of predetermined length cut from the second material web has reached the predetermined position relative to the first material web.

According to an advantageous further aspect of the device of the present invention, provision is made for n dispensing devices arranged at a relative distance of (2n+1)*(b+z), where b is the width of the sections of the second material web, and z the desired distance between two consecutive sections of the second material web. This embodiment permits the n dispensing devices to work parallel to each other, i.e., without time off-set. Obviously, the control effort is thus reduced considerably.

The advantages of a further aspect of the device of the present invention, which involve the setting of the running speed of the first material web so that the sections of predetermined length of the second material web are applied to the first material web in a continuous process, have already been mentioned in the foregoing.

Advantageously, provision is made for a take-up reel onto which the finished web material is wound.

The object of the invention with regard to the security element is accomplished in that the first material web is a continuous material web to which the sections of a predetermined length cut from a second material web made of a magnetic material are conveyed in a direction transverse to the running direction (x) of the first material web and applied thereto.

Preferably, the first material web is a substrate; the sections of a predetermined length (l) cut from the second material web are adhesive labels, each containing at least one security element for electronic article surveillance

Alternatively, the security elements are a plurality of deactivatable or non-deactivatable strip elements arranged parallel to each other and in a direction transverse to the running direction (x) of the first material web.

A further embodiment of the security element of the resent invention provides for the first material web to be a thin-film material whose preferential direction extends transverse or parallel to the running direction (x) of the first material web, and for the sections of predetermined length (l) cut from the second material web to be equally thin-film labels whose preferential direction extends respectively parallel or transverse to the running direction (x) of the first material web.

Similarly, it is possible for the sections of a predetermined length cut from the second material web to be resonant labels.

The present invention will be explained in more detail in the following with reference to the accompanying drawing. In the drawing;

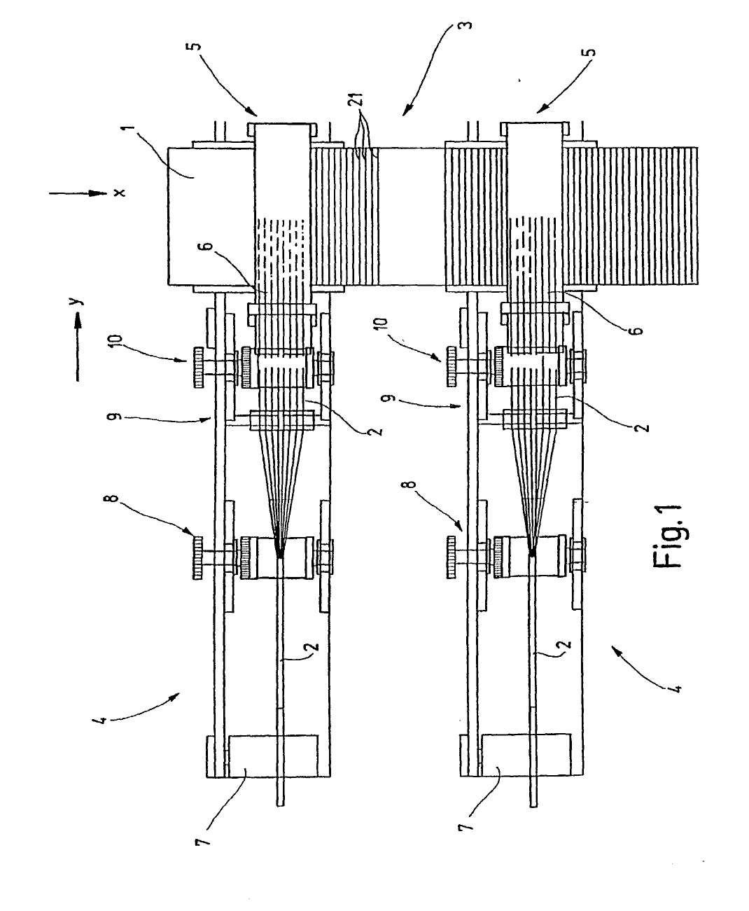

FIG. 1 is a top plan view of an embodiment of the device of the present invention;

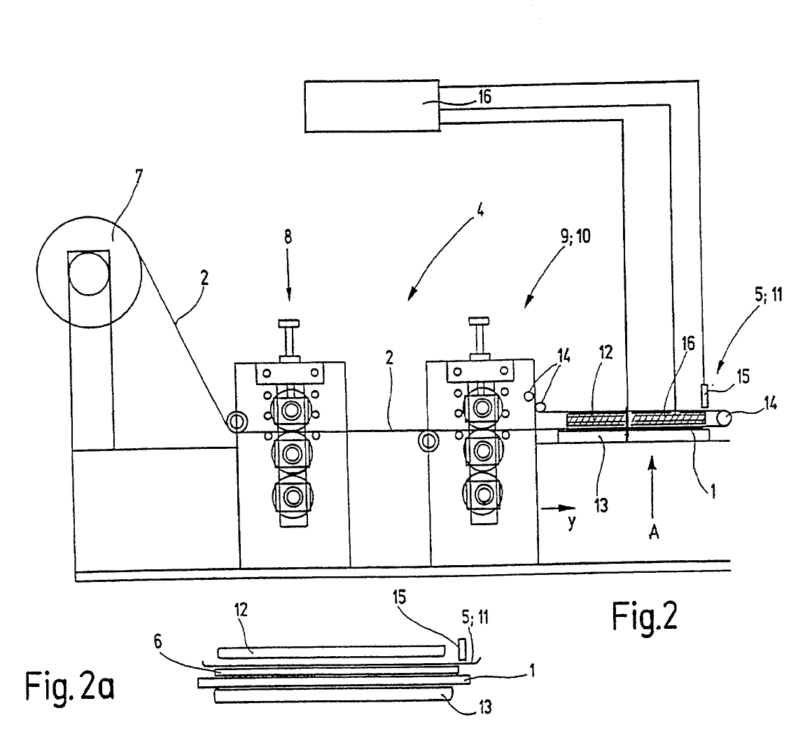

FIG. 2 is a longitudinal sectional view of the dispensing device of FIG. 1;

FIG. 2a is a view, on an enlarged scale, of detail A of FIG. 2; and

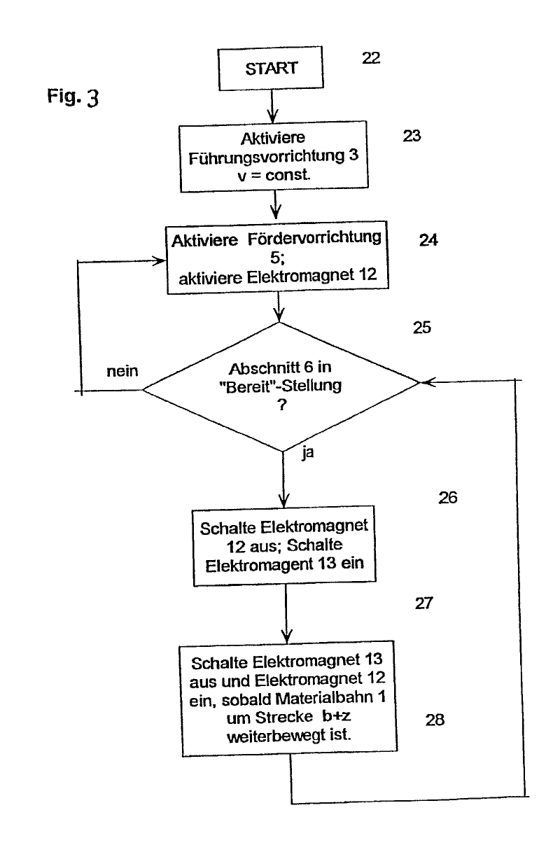

FIG. 3 is a flow diagram for controlling the control/regulating unit.

FIG. 1 shows a top plan view of an embodiment of the device of the present invention. FIG. 2 shows a longitudinal section of the conveying device 4 and a cross section of the guide device 3.

In the embodiment shown, the material web 2 is a soft magnetic strip from which elements referred to as strip elements for electronic article surveillance are made. The material web 2 is unwound from the supply reel 7 and divided in the longitudinal cutting unit 8 into strips of the desired width. The web material 2, which has been divided into individual strips, is then fanned out in the fanning unit 9 so that the individual strips are a desired distance apart, after which it is cut in the cross cutting unit 10 into sections of the desired length (l). The adjacent lying soft magnetic strips of predetermined length (l) are picked up by the conveyor belt 11 and transferred over the cross-running material web 1. Feeding the sections 6 of strip elements over the material web 1 is performed by an electromagnet 12 arranged in the interior of the conveyor belt 11, which is guided around guide rollers 14. During this transfer cycle the electromagnet 12 is consequently activated. As soon as the section 6 with the strip elements has reached the correct position relative to the first material web 1—this information is received by the control/regulating unit 16 from the sensor 15—the control/regulating unit 16 switches off the electromagnet 12 and activates the electromagnet 13 arranged underneath the first material web 1. The sections 6 with strip elements are applied to the adhesive side of the material web 1 through the force of magnetic attraction. As soon as the section 6 with strip elements applied to the material web 1 is moved through underneath the dispensing device 4, the electromagnet 13 is switched off again.

FIG. 3 shows a flow diagram for controlling the control/regulating unit 16. The program is started at 22. The guide device 3 for the first material web 1 is activated in program point 23. At the same time the conveying device 4 for feeding the sections 6 and the electromagnet 12 are activated. The electromagnet remains activated until the section 6 has reached the “ready” position, meaning the correct position relative to the material web 1. This check is performed in program point 25. As soon as the correct “ready” position of the section 6 is reached, the electromagnet 12 is switched off in program point 26 while the electromagnet 13 is switched on. The section 6 is applied by force of magnetic attraction to the adhesive side of the material web 1. The application operation is repeated in cycles as soon as the material web 1 is moved on a distance of at least 1+z.

### List of References

1 first material web

2 second material web

3 guide device

4 dispensing device

5 conveying device

6 section

7 supply reel

8 longitudinal cutting unit

9 fanning unit

10 cross cutting unit

11 conveyor belt

12 electromagnet

13 electromagnet

14 guide roller

15 sensor

16 control/regulating unit

17 supply reel

18 adhesive device

20 web material

21 security element

1. A method for the production of security elements for electronic article surveillance, said security elements being comprised of at least two layers,
characterized in that sections (6) of a second web material (2) cut to a predetermined length (1) are conveyed in a direction transverse to the running direction (x) of a first continuous material web (1) and are applied to said first material web (1).

2. The method as claimed in claim 1,
characterized in that the feeding of the sections (6) of predetermined length (1) cut from the second material web (2) is performed in steps or continuously.

3. A device for the production of security elements for electronic article surveillance, said security elements being comprised of at least two layers,
characterized in that a guide device (3) is provided for a first material web (1), at least one dispensing device (4) is provided for feeding the sections (6) of a predetermined length (1) cut from a second material web (2) at right angles to the guide device (3), and at least one conveying device (5) is provided to take successively from the dispensing device (4) said sections (6) of predetermined length cut from the second material web (2) and affix them to the first material web (1) either side by side or with a gap in between in a direction transverse to said first material web (1).

4. The device as claimed in claim 3,
characterized in that the dispensing device (5) is a conveyor belt (11), at least one electromagnet (12) is positioned in the inner space formed by the revolving conveyor belt (11), at least one further electromagnet (13) is provided in the area underneath the first material web (1) where the sections (6) of the second material web (2) are applied to the first material web (1), and a control/regulating unit (16) is provided to switch the electromagnets (12, 13) on and off so that the sections (6) of the second material web (2) are applied to the first material web (1).

5. The device as claimed in claim 4,
characterized in that a stop or a sensor (15) for detecting the correct position of the sections (6) of the second material web (2) relative to the first material web (1) is provided, and the control/regulating unit (16) switches the first electromagnet (12) off and the second electromagnet (13) on as soon as the stop or the sensor (15) signals that the section (6) of predetermined length (1) cut from the second material web (2) has reached the predetermined position relative to the first material web (1).

6. The device as claimed in claim 3,
characterized in that provision is made for n dispensing devices (4) arranged at a relative distance of (2n+1)*(b+z), where b is the width of the sections (6) of the second material web (2) and z the desired distance between two consecutive sections (6) of the second material web (2).

7. The device as claimed in claim 6,
characterized in that the running speed of the first material web (1) is set by the control device (16) in such manner that the sections (6) of predetermined length (1) of the second material web (2) are applied to the first material web (1) in a continuous process.

8. The device as claimed in claim 3,
characterized in that provision is made for a take-up reel onto which the finished web material (20) is wound.

9. A web material with security elements for electronic article surveillance, one security element being comprised of at least two layers,
characterized in that the first material web (1) is a continuous material web to which sections (6) of a predetermined length (1) cut from a second material web (2) made of a magnetic material are conveyed in a direction transverse to the running direction (x) of the first material web (1) and applied thereto.

10. The web material as claimed in claim 9,
characterized in that the first material web (1) is a substrate and the sections (6) of a predetermined length (1) cut from the second material web (2) are adhesive labels, each containing at least one security element (21) for electronic article surveillance.

11. The web material as claimed in claim 10,
characterized in that the security elements (21) are a plurality of deactivatable or non-deactivatable strip elements arranged parallel to each other and in a direction transverse to the running direction (x) of the first material web (1).

12. The web material as claimed in claim 9,
characterized in that the first material web (1) is a thin-film material whose preferential direction extends transverse or parallel to the running direction (x) of the first material web (1), and the sections (6) of predetermined length (1) cut from the second material web (2) are equally thin-film labels whose preferential direction extends respectively parallel or transverse to the running direction (x) of the first material web.

13. The web material as claimed in claim 9,
characterized in that the sections (6) of predetermined length (1) cut from the second material web (2) are resonant labels.
